(19) United States
(12) Patent Application Publication
(10) Pub. No.: US 2026/0285234 A1
(43) Pub. Date: Sep. 24, 2026

(54) RUNNING BOARD FOR A MOTOR VEHICLE

(71) Applicant: Brose Fahrzeugteile SE & Co. Kommanditgesellschaft, Bamberg, Bamberg (DE)

(72) Inventor: Daniel FOERST, Bamberg (DE)

(73) Assignee: Brose Fahrzeugteile SE & Co. Kommanditgesellschaft, Bamberg, Bamberg (DE)

(21) Appl. No.: 19/087,059

(22) Filed: Mar. 21, 2025

(51) Int. Cl. B60R 3/00; B60Q 1/50; E05F 15/48

(52) U.S. Cl. CPC B60R 3/002; B60Q 1/543; E05F 15/48; E05Y 2900/531

(57) ABSTRACT

A running board for a motor vehicle having a board arranged in a longitudinal direction, and having a holder on which the board is mounted so as to be tiltable about a pivot axis running parallel to the longitudinal direction. The running board also comprises a sensor for detecting tilting. Further, a flap system for a motor vehicle is provided.

### BACKGROUND OF THE INVENTION

### Field of the Invention

The invention relates to a running board for a motor vehicle and to a flap system for a motor vehicle, having a running board.

### Description of the Background Art

Motor vehicles, such as passenger cars, usually have a number of flaps, via which an opening in the body of the motor vehicle is covered. The flap is usually movably mounted on the body of the motor vehicle via a bearing, so that the opening of the body can be released by moving the flap. If the flap is a side door, it is therefore possible to enter the interior of the motor vehicle and/or load the interior with objects. To increase comfort, the flap is usually driven by an electric motor.

If the flap is moved from an open position to a closing direction so that the opening is covered, it is possible that an extremity of a user or other person may be located between the flap and the edge of the opening formed via the body. Because a relatively powerful electric motor is usually used to move the flap, it is possible that the extremity becomes trapped between the flap and the body, which can lead to relatively serious injuries.

For this reason, it is necessary to provide a so-called anti-pinch sensor. For this purpose, the space between the flap and the body is usually monitored for the presence of an obstacle. Monitoring is done optically via a camera, for example. To check the created image data to see whether the obstacle is present, a relatively extensive data analysis is required, which is why a hardware requirement and therefore also the manufacturing costs are increased. Alternatively, a radar sensor can be used, for example. However, due to the radar waves emitted, there are usually certain regulatory requirements and certification is required. The amount of energy required for operation is also relatively high. Another alternative proposes using a capacitive sensor. In this regard, it is necessary in particular to arrange it along the entire edge of the opening, which is why it is relatively large and therefore cost-intensive. Installation is also complex. In addition, such a sensor is weather-sensitive. Thus, for example, precipitation in the area of the sensor can be falsely detected as an obstacle.

Relatively high vehicles, such as off-road vehicles or pick-up trucks, usually have running boards with a tread surface, also known as treads, for easier entry. These are mounted below a door and extend from the lower end of the body towards the ground. Thus, a person can step onto the tread surface when entering and leaving and use the running board as an intermediate step, so that they can also overcome relatively large differences in height.

### SUMMARY OF THE INVENTION

It is therefore an object of the invention to provide a particularly suitable running board for a motor vehicle and a particularly suitable flap system, whereby manufacturing costs are expediently reduced, and whereby security and/or robustness are expediently increased.

In an example, the running board is suitable, in particular provided and configured, to be mounted on a motor vehicle or at least to form a component of the motor vehicle in the assembled state. The motor vehicle is suitably designed to be land-based and preferably multi-lane. In this case, it is suitably possible to position the motor vehicle essentially freely, in particular on a roadway. For this purpose, the motor vehicle expediently has appropriate wheels. In summary, it is preferably possible to position the motor vehicle essentially independently of other conditions on land. In other words, the motor vehicle is suitably not rail-guided. For example, the motor vehicle can be a passenger car or a commercial vehicle, such as a truck or bus.

The running board may have a board. The board can be used for climbing up and/or for support for one person and is suitable, in particular provided and configured, for this purpose. In other words, the board can be a type of step or acts like a step. The board expediently can have a tread surface for this purpose. For example, the tread surface is made of a relatively low-slip material and/or is relatively robust so that the person thereon is supported/braced without an injury occurring. In the intended state, the tread surface is expediently arranged substantially horizontally. The board is arranged along a longitudinal direction. In other words, the board has a main dimension that is parallel to the longitudinal direction. The longitudinal direction is in particular parallel to a horizontal. The longitudinal direction in which the board is arranged is particularly preferably substantially parallel to the longitudinal axis of the motor vehicle, in particular an X-axis of a vehicle coordinate system.

Preferably, the board can be associated with a flap of the motor vehicle and can be arranged, in particular, vertically below the flap. The flap is, for example, a door, such as a side door. This is mounted, for example, so as to be pivotable or longitudinally displaceable on the body. Alternatively, the doors can be arranged in a rear area and are designed in particular as swing doors. The board can be expediently located in a vertical direction under an opening in the body assigned to the door. For example, the motor vehicle can be designed in the manner of a train, a streetcar, or a bus. However, the motor vehicle is particularly preferably a passenger car and is designed, for example, in the manner of a van, off-road vehicle, or pick-up truck. In a further alternative, the flap is, for example, a tailgate, and the board, in the intended state, is, for example, partially offset laterally in relation to the flap, in particular if the vehicle is designed in the manner of a pick-up truck.

The running board can further comprise a holder to which the board is attached. In the assembled state, the holder is expediently attached, for example, fastened, to a body of the motor vehicle. Thus, the board is fastened to the body via the holder and is thus stabilized with respect to the body via the holder. Due to the holder, it is possible to position the board in a specific place, which is why comfort is increased for a user.

The board can be mounted on the holder around a pivot axis running parallel to the longitudinal direction. In other words, it is possible to tilt the board at least partially around the pivot axis with respect to the holder. In particular, the extent to which the board can be tilted with respect to the holder is limited and is expediently less than 10° or 5°. In particular, the board can be tilted with respect to the holder only by an angle between 0.5° and 5° or between 1° and 2°. In summary, the board can be tilted with respect to the holder by an adjustment angle and thus can be adjusted along an adjustment path. In particular, the pivot axis is offset away from a center of the board and, for example, from an edge of the board by a maximum of a fourth of the extent perpendicular to the longitudinal direction. Alternatively, for example, the pivot axis is spaced apart from the board.

Further, the running board can have a sensor for detecting tilting. The sensor is thus suitable, in particular provided and configured, to detect the tilting of the board with respect to the holder. For example, the sensor is designed to quantitatively determine the tilting, or via it, for example, the tilting can only be detected in binary form, therefore, one of two states that correspond in particular to the ends of the adjustment path.

If a user has supported themselves on the board or is standing on it, for example, because they want to leave the opening or climb in through it, an additional weight force acts on the board. The additional load then leads to the tilting of the board with respect to the holder, and the running board is expediently designed accordingly. This tilting can then be detected via the sensor. Thus, it can be determined via the sensor whether the running board is currently being used, therefore, whether a person is in the area of the opening assigned to the flap, and thus whether there is a risk of pinching. In particular, in this case, closing of the flap is prevented and/or a warning is issued. If, in contrast, no additional weight force acts on the running board, in particular because the user is not supported by it or standing on it, it is not ruled out admittedly that an extremity of the user is located in the area of the opening. To exclude this, however, only a relatively small spatial area needs to be monitored, which is why an appropriately designed, small, and cost-effective (additional) anti-pinch sensor can be used.

Thus, manufacturing costs are reduced, whereby safety is increased. In this case, the detection of the tilting via a relatively inexpensive sensor is reliably enabled, because the sensor can be positioned relatively close to the board. Thus, the requirements for the sensor's detection range are reduced. The sensor can also be disposed so as to be protected from the weather, which is why detection can take place substantially independent of the weather, which is why robustness is increased.

For example, the board can be mounted directly on the holder and in particular in direct mechanical contact with the holder. Alternatively, for example, a hanger is rigidly fastened to the board, preferably rigidly. The hanger, in turn, is mounted on the holder. In this case, the hanger is expediently substantially L-shaped. In this way, it is possible to appropriately move the pivot axis with respect to the board and, in particular, to arrange it at a distance from the board, which is why sufficient tilting occurs even with a relatively small and/or adjustable additional weight force.

For example, the hanger can be mounted on the holder so as to be pivotable through a relatively large angle. However, this mounting exists in addition to the tiltable mounting. Thus, in particular, the pivotable mounting is limited via a stop or the like, and the tilting takes place in particular by a further tilting being carried out via the stop. In particular, the stop or other mechanism is thus designed in such a way that tilting only occurs when the board is loaded with the additional weight force.

For example, the holder can be formed via a strut or preferably comprises a plurality of corresponding struts. These are suitably offset from one another in the longitudinal direction. Preferably, the struts are structurally identical to one another, which is why manufacturing costs are reduced. Due to the struts it is thus possible to keep the board relatively stable, whereby the weight of the holder is relatively low. If the holder comprises a plurality of struts, each of them is expediently assigned a corresponding hanger. Thus, stability is increased and construction is simplified.

For example, the board can be substantially loosely mounted on the holder. However, the board is particularly preferably pretensioned. For this purpose, the board is supported on the holder, for example, via a spring, for example, directly. Alternatively, there is preferably a hanger to which the board is fastened and which is pretensioned with respect to the holder, whereby the spring is arranged between the holder and the hanger. Thus, the board is supported on the holder via the hanger and is thus pretensioned. A spiral spring or a leaf spring, for example, is used as the spring. It is particularly preferred to use an elastically deformable element as the spring, which is made, for example, of rubber or caoutchouc. Thus, manufacturing costs are reduced and robustness is increased.

Particularly preferably, the board can be pretensioned in such a way that the spring is tensioned when the additional weight force acts on the board, in particular because the user has stood on it. As soon as the additional weight force decreases, the board is then pivoted back to its original position. Consequently, due to the pretensioning, in particular due to the spring, the board is located at one of the ends of the adjustment path. By checking at which of the two ends of the adjustment path the board is located, it is therefore possible to determine whether the additional weight force is acting or not, therefore, whether the board is currently being used. Therefore, requirements for the sensor are reduced, which is why manufacturing costs are reduced.

For example, a capacitive sensor or a radar sensor can be used as a sensor. Particularly preferably, the sensor comprises a microswitch which is assigned to the board and the holder. In this case, the microswitch is expediently arranged such that the microswitch has one switching state when the board is at one of the two ends of the adjustment path and that the microswitch has the other switching state when the board is at the other end of the adjustment path. Thus, the microswitch has one of the two switching states as a function of the additional weight force. Due to the microswitch, manufacturing costs are relatively low. In addition, robustness is increased and space requirements are reduced. For example, the microswitch is fastened to the board and supported on the holder. However, the microswitch is particularly preferably fastened to the holder, which simplifies wiring. The hanger is preferably present, via which the microswitch is actuated as a function of the additional weight load.

For example, the sensor can be formed via the microswitch. Particularly preferably, the sensor comprises two such microswitches which are assigned to different ends of the board in the longitudinal direction. In particular, the two microswitches are thus offset from one another in the longitudinal direction. Suitably, in this regard, the holder comprises the struts which are offset from one another in the longitudinal direction, for example, two such struts. Each of the struts is expediently assigned to one of the microswitches. Each strut is preferably assigned to one of the microswitches, so that the sensor has just as many switches as there are struts. Due to the plurality of microswitches, it is possible, for example, to determine at which end of the board the additional weight load occurs. If the running board is assigned to a plurality of flaps which are offset from one another in the longitudinal direction, it is thus possible to determine in particular at which of the two flaps there is a possible risk of pinching.

For example, the holder in the assembled state can be rigidly fastened to a body of the motor vehicle. Alternatively, the holder can be suitably adjustably mounted. In particular, due to the adjustable mounting, it is possible to change the distance of the board to the ground and/or to at least partially position the protrusion of the board over other components of the body. Thus, comfort is increased when the running board is to be used. However, in contrast, if the running board is not to be used, it is possible to store the board, which avoids damage to the board.

For example, the holder may only be adjusted manually. Alternatively, it is designed, for example, in such a way that when a locking mechanism is released, the holder assumes a corresponding position due to the acting weight force, and/or the holder is pretensioned. In this way, manufacturing costs are reduced. Particularly preferably, however, the holder is driven via a drive which is in particular designed as an electric motor drive. Thus, comfort is increased. The electric motor drive preferably comprises an electric motor. The electric motor is, for example, a brushed commutator motor or alternatively designed as brushless. For example, the electric motor is a brushless direct current motor (BLDC). The electric motor preferably has a stator and a rotor which is mounted so as to be rotatable with respect to the stator about a rotation axis/axis of rotation, which thus corresponds to the rotation axis of the electric motor. The electric motor is designed in such a way that when the electric motor is energized, a rotating magnetic field is created, as a result of which the rotor is caused to rotate with respect to the stator. Preferably, the electric motor comprises a housing via which the stator is at least partially surrounded and consequently protected. Suitably, the electric motor drive comprises a gear unit which is driven via the electric motor. The holder is in turn driven via the gear unit.

In this case, the holder can comprise the strut, which in particular is mounted pivotably on the body in the assembled state; in this case, the pivot axis of the strut is expediently also parallel to the longitudinal direction, so that the board can be stowed in a relatively space-saving manner underneath a body of the motor vehicle when the latter is not to be used. Also, the strut can be arranged to be at least partially longitudinally displaceable, for example. Preferably, due to the pivotable mounting, it is possible to move the holder transversely to the longitudinal direction or at least the board. Thus, an angle is suitably formed between the direction in which the board can be moved and the longitudinal direction, which angle is in particular between 70° and 110° or between 80° and 100° and is, for example, equal to 90°.

In the assembled state, the flap system can be a component of a motor vehicle, such as a passenger car. The flap system is suitable, in particular provided and configured, for this purpose. The flap system has a flap. This is designed, for example, as a tailgate. Alternatively, the flap is a door, such as a side door. In the assembled state, this is mounted on the body of the motor vehicle in a sliding or pivotable manner, for example. The flap system expediently comprises a corresponding mounting for the associated flap.

The flap system further comprises a running board assigned to the flap. In this case, the running board is arranged, for example, in the intended state in a vertical direction below the flap, in particular if the flap is designed as a door. This makes it easier for a person to enter the vehicle through an opening that can be closed via the associated flap. If the flap is designed as a tailgate, the motor vehicle is expediently designed in the manner of a pick-up truck. In this case, the flap is preferably mounted so as to be pivotable about a horizontal axis. In particular, when the flap is open, it is flush with a loading surface. In this case, the running board is expediently arranged both vertically below the flap and laterally offset to it, and in particular is designed as a so-called sidestep. Thus, this allows the running board to be used even when the flap is open.

The running board can have a board arranged in a longitudinal direction and a holder on which the board is mounted so as to be tiltable about a pivot axis running parallel to the longitudinal direction. The running board further comprises a sensor for detecting tilting.

For example, the flap can only be adjusted manually. Particularly preferably, however, the flap system comprises an additional drive via which the flap is driven. The additional drive expediently comprises an additional electric motor, which is designed, for example, as a brushed commutator motor or expediently as a brushless direct current motor (BLDC). In particular, another gear unit, such as a worm gear unit, is driven via the additional electric motor. This in turn drives, for example, a spindle or other component that is supported on the flap. At least during operation of the additional drive, a force is exerted on the flap, and the flap system is designed accordingly. For example, during operation of the additional drive, the flap is adjusted completely automatically, or manual adjustment by a user/person is at least supported, so that the force to be applied by the user is reduced.

In particular, the flap system can be designed in such a way that a request can be detected. For example, the flap system comprises a corresponding input device for this purpose, such as a button or a handle, which can be actuated by the user. Alternatively, the flap system comprises an interface via which the actuation of a corresponding input device can be detected. In particular, after the request has been detected, the additional drive is operated so that the flap is moved.

For example, the flap can be driven independently of the tilting, therefore, in particular, independently of the measurement and/or sensor data provided via the sensor. Particularly preferably, however, the flap can be driven via the additional drive as a function of the tilting. In particular, this prevents the flap from being moved when the board is tilted, therefore, especially when the additional weight force acts on the board. In this case, for example, movement of the flap is prevented at the outset, so that the additional drive in particular is stopped and operation is prevented. If in this case the possible request to move the flap is detected, the additional drive is not operated so that the flap is not moved. Thus, when the user is supported on the board and the request is detected, the user will not be frightened, which increases their comfort and also eliminates a danger.

If the board is tilted during movement of the flap and a corresponding operation of the additional drive, in particular due to the additional weight force, the additional drive can be shut down so that the flap is stopped. Thus, if the user or another person would like to enter or leave while the flap is being moved using the additional drive, the flap will be stopped so that any danger is ruled out.

For example, the operation of the additional drive always takes place as a function of the tilting, therefore, during both an opening movement and a closing movement of the flap. Alternatively, the operation of the additional drive takes place, as a function of the tilting, only during a closing movement. If thus even during an opening movement of the flap, the user leaves the vehicle and steps onto the board, this does not lead to a termination of the flap movement, which is why comfort for the user is increased.

For example, the flap system comprises two flaps to which the same running board is assigned. Preferably, the running board comprises the two microswitches or other sensor units which are assigned to different ends of the board in the longitudinal direction. In this case, it is preferably determined at which end of the board the additional weight force acts, therefore, in particular where the greater tilting prevails. The additional flap drive, which is assigned to this end of the board, is then expediently stopped. Consequently, danger to the user is ruled out there, whereby movement of the additional flap also continues to be possible, which increases comfort.

Alternatively or in combination with the operation of the additional drive as a function of the tilting, a warning is issued, for example, as a function of the tilting. The warning is expediently issued here when the additional weight force acts or at least a correspondingly assigned tilting is detected. Preferably, a lamp with a signal color, such as red, is activated to issue the warning in the area of the flap. For example, the warning is issued directly via the flap system, for example, visually and/or acoustically. For this purpose, the flap system expediently has a corresponding output device. Alternatively or in combination hereto, the warning is transmitted to an on-board computer of the motor vehicle, so that appropriate actions can be initiated via the on-board computer. Flexibility is thus increased.

For example, the warning may always be issued when the additional weight force acts, therefore, when the board has a certain tilting state. Alternatively, the warning will only be issued if an additional condition is met. The additional condition is expediently met when the additional drive is operated or there is at least one request to operate the additional drive. Preferably, in this case, the additional drive is driven as a function of the tilting. Thus, if the additional drive is stopped, the user will be informed by a warning why the flap is not being opened, so that a fault in the flap system is not wrongly assumed.

The flap system is expediently operated according to a method in which, as a function of the tilting, the possible additional drive is operated and/or the warning is issued. Suitably, the flap system has a control unit which is provided and configured to carry out the method. The control unit comprises, for example, an application-specific integrated circuit (ASIC) or, particularly preferably, a computer which is suitably designed to be programmable. In particular, the control unit comprises a storage medium on which a computer program product, also referred to as a computer program, is stored, whereby when this computer program product, therefore, the program, is executed, the computer is caused to carry out the method.

The invention further relates to a corresponding method and such a computer program product. The computer program product comprises a number of instructions which, when the program (computer program product) is executed by a computer, cause the computer to carry out the method. The computer is expediently a component of a control unit or electronics of the flap system and is formed, for example, via these. The computer preferably comprises a microprocessor or is formed via it. The computer program product is, for example, a file or a data carrier which contains an executable program which, when installed on a computer, automatically carries out the method.

The invention further relates to a storage medium on which the computer program product is stored. Such a storage medium is, for example, a CD-ROM, a DVD, or a Blu-Ray disc. Alternatively, the storage medium is a USB stick or other storage device that is, for example, rewritable or can only be written to once. Such a memory is, for example, a flash memory, RAM, or ROM.

The invention further relates to a control unit. The control unit is provided and configured to carry out the method. The control unit has, for example, an application-specific integrated circuit (ASIC) and/or a microprocessor, via which the method is at least partially carried out. In particular, the control unit comprises a computer program product which is stored in a memory and which, when the program is executed by a computer, such as the microprocessor, causes the latter to carry out the method. Preferably, the control unit is a component of the flap system in the assembled state and is suitable, in particular provided and configured, for this purpose.

The invention further relates to a motor vehicle with a corresponding flap system. The motor vehicle is suitably land-based and, for example, a passenger car. Alternatively, the motor vehicle is a commercial vehicle, for example, a truck or bus. The motor vehicle comprises in particular a body with an opening. In this case, the opening can be covered via the flap, which is expediently adjustably mounted on the body in a movable manner, for example, via a hinge and/or a guide rail.

The advantages and refinements mentioned in connection with the running board are to be applied analogously to the flap system/the method/the computer program product/the storage medium/the control unit/the motor vehicle as well as to one another other and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a motor vehicle, which comprises a flap system with a flap designed as a door and a running board, which comprises a board arranged in a longitudinal direction;

FIGS. 2 to 4 schematically show different states of the flap system in a sectional view perpendicular to the longitudinal direction; and

FIG. 5 shows a method for operating the flap system.

### DETAILED DESCRIPTION

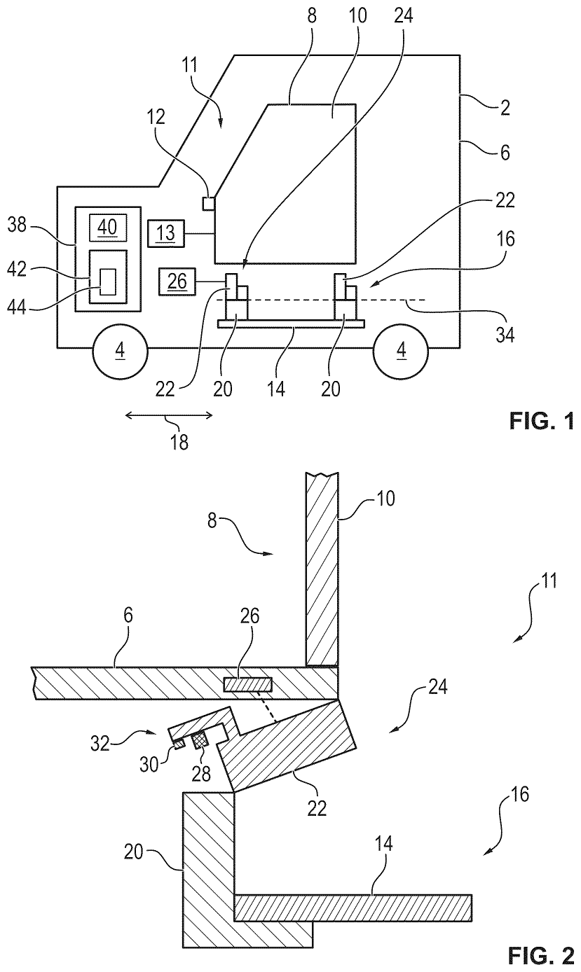

In FIG. 1, a motor vehicle 2 in the form of a passenger car is shown in a schematically simplified view. Motor vehicle 2 has a plurality of wheels 4 which rest on the ground and which are connected to a body 6 via a chassis. Motor vehicle 2 is designed as a pick-up truck and has relatively large wheels 4 and a correspondingly designed chassis. As a result, a lower edge of body 6 is relatively far away from the ground.

Body 6 has an opening 8 which can be covered via a flap 10 of a flap system 11. For this purpose, flap 10, which is designed as a side door, is movably mounted on body 6 via a hinge 12. Flap 10 is driven via an additional drive 13 of flap system 11 which drive is held stationary on body 6 and which has an electric motor. Flap 10 is then pivoted during operation of the electric motor. In this case, it is possible to carry out an opening movement so that flap 10 is moved in an opening direction which is predetermined via hinge 12. When flap 10 is moved along the opening movement, opening 8 is released. Via the opposite direction current supply to the electric motor of additional drive 13, in contrast, a closing movement is carried out and flap 10 is moved in a closing direction which is opposite to the opening direction and is also predetermined via hinge 12. When the closing movement has completely ended, opening 8 is covered by flap 10 and thus closed.

A board 14 of a running board 16 is located in the vertical direction below the door. Board 14 is arranged horizontally and has a main dimension in a longitudinal direction 18. In other words, board 14 is arranged in the longitudinal direction 18. Board 14 is rigidly fastened to two L-shaped hangers 20 of flap system 11, which is shown in different states in FIGS. 2-4.

The two hangers 20 are spaced apart from one another in the longitudinal direction 18 and board 14 is assigned to different ends in the longitudinal direction 18. Each hanger 20 is pivotably mounted on a strut 22 of a holder 24, which in turn is mounted in a pivotable manner on the body. Holder 24, namely, struts 22, is in turn driven by a drive 26, which comprises an electric motor and a gear unit driven thereby. Consequently, holder 24 is adjustably mounted and driven via drive 26.

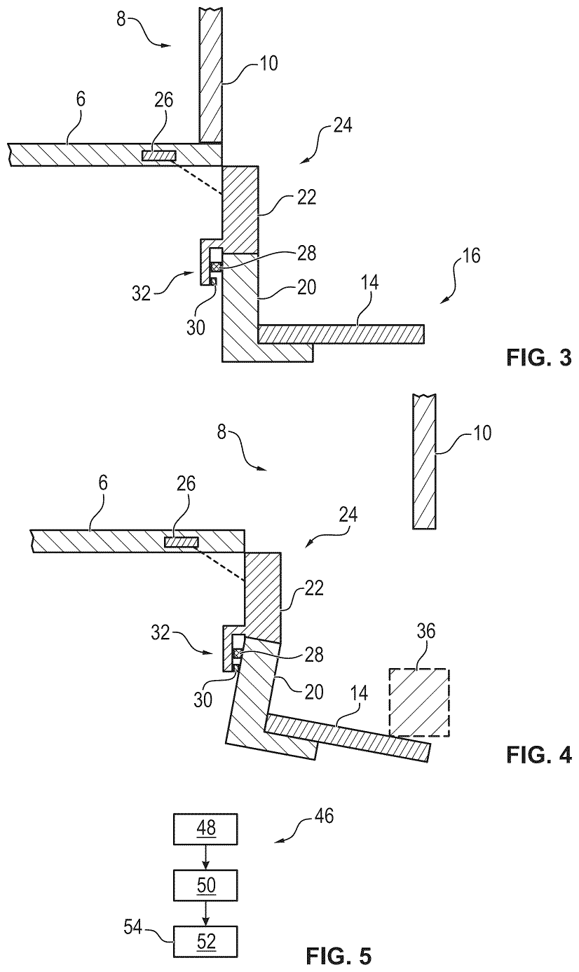

In this case, it is possible to move board 14 into a retracted state, which is shown in FIG. 2. In this state, struts 22 are folded in the direction of body 6 so that board 14 is located partially below body 6 in a vertical direction. Also, the lateral protrusion over body 6 is reduced. By energizing the electric motor of drive 26, it is possible to align struts 22 substantially perpendicular to body 6, which is why board 14 is spaced apart from body 6 in the vertical direction and a lateral protrusion over body 6 is increased, as shown in FIG. 3. In this case, board 14 is in an extended state and board 14 can be used by a user to reach the ground from opening 8 and vice versa, so that the full distance from opening 8 to the ground does not have to be bridged in one step.

When moving from the retracted state to the extended state, hangers 20 are pivoted relative to struts 22 so that board 14 always remains substantially horizontal. In this case, hangers 20 are forcibly guided via a mechanism, so that they are not loosely pivoted, but so that their position with respect to struts 22 is also predetermined via drive 26.

In the extended state, a spring 28 in each case in the form of an elastic element is arranged in a force-fitting manner between each strut 24 and the associated hanger 20, which spring is at least partially elastically deformed. Thus, holders 24 are pretensioned with respect to struts 22 and therefore also board 14 is indirectly pretensioned on holder 24. In addition, fastened to each strut 22 is a microswitch 30 of a sensor 32, which is spaced from the respective associated hanger 20 and is therefore not actuated. In other words, sensor 32 thus has the two microswitches 30 which are assigned to the different ends of board 14 in the longitudinal direction 18.

In the extended state, board 14 is further mounted so as to be tiltable about a pivot axis 34 running parallel to the longitudinal direction 18, which is parallel to the longitudinal axis of motor vehicle 2, namely, by a maximum angle of 2°. The extent of the tilting is not determined by drive 26 and the corresponding mechanics, but merely due to an additional weight force that acts when an object 36 is placed on board 14, as shown in FIG. 4. With the exception of spring 28, board 14 is thus loosely mounted on holder 24, namely, via hangers 20, so as to be tiltable, whereby it is ensured via spring 28 that, when object 36 is not present, board 14 is in a defined position, namely, the extended state shown in FIG. 3.

However, if object 36 rests on board 14, for example, because the user is standing on board 14 when entering or leaving through opening 8, the tilting occurs, whereby springs 28 are compressed and elastically deformed. In this case, microswitches 30 of sensor 32 are also actuated.

Microswitches 30 are designed in such a way and board 14 is mounted in such a way that if only a load is applied to one of the ends of board 14 in the longitudinal direction 18, only microswitch 30 assigned to the same end is actuated. Thus, sensor 32 serves to detect the tilting, namely, the binary state, whether the tilting is present, as shown in FIG. 4 in the extended and loaded state of running board 16, or whether no tilting prevails, as in the retracted and extended states (FIGS. 2 and 3).

Flap system 11 further has a control unit 38 with a computer 40 in the form of a microprocessor. Control unit 38 also comprises a memory 42 on which a computer program product 44 is stored. Computer program product 44 comprises a number of instructions which, when executed by computer 40, cause the computer to carry out a method 46 shown in FIG. 5 for operating flap system 11. In other words, flap system 11 is operated according to method 46.

In method 46, in a first step 48, a request to close flap 10 is received. In this case, In the example shown, method 46 is only carried out when flap 10 is open. In principle, however, it is also possible to carry out the method if the request corresponds to an opening movement.

The request is made by a user via an input device, such as a handle attached to flap 10. It is also possible to create the request via an on-board computer of motor vehicle 2, for example, depending on current requirements and/or a state of motor vehicle 2. In this case, the request is transmitted from the on-board computer to control unit 38, for example, via a bus system.

A second step 50 is then carried out. In this step, the additional drive 13 is energized so that flap 10 is closed. This continues until opening 8 is closed via flap 10 and flap 10 rests against body 6. Then the power supply to additional drive 13 is terminated and drive 26 is energized so that running board 16 is placed in the retracted state.

However, if during the movement of flap 10, therefore, if opening 8 is not yet completely covered by flap 10, a tilting of board 14 is detected by sensor 32, as shown in FIG. 4, a third step 52 is carried out. The tilting is detected when one of microswitches 28 is actuated. This occurs, for example, when the user wants to enter into or leave motor vehicle 2 through the door that is not yet completely closed. In this case, there is a risk of pinching of the user between flap 10 and body 6.

In third step 52, additional drive 13 is stopped so that flap 10 remains in the current position. Further, a warning 54 is issued. Warning 54 is issued visually, for which a lamp of flap system 11 is activated. The lamp has a signal color, such as red, so that the user becomes aware of the potential danger of pinching. Warning 54 is also sent to the on-board computer, via which further functions can be carried out. At least the current state of flap system 11 is transmitted to the on-board computer.

If the existing tilting is already detected by sensor 30 after the request has been received, therefore, before additional drive 13 is operated and flap 10 is moved, the third step 52 is carried out directly after the first step 48, and thus additional drive 13 is not operated and warning 54 is also issued.

In summary, drive 13 is always driven as a function of the tilting, and warning 54 is also issued as a function of the tilting. If board 14 is assigned to two flaps 10 offset from one another in the longitudinal direction 18, it is possible that only one of the two microswitches 28 is actuated, namely, when only one of the ends of board 14 is loaded. In this case, in third step 52, additional drive 13 is stopped, via which flap 10 is operated, which is located at the same end of board 14 as the actuated microswitch 28.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A running board for a motor vehicle, the running board comprising:
a board arranged in a longitudinal direction;
a holder on which the board is mounted so as to be tiltable about a pivot axis running substantially parallel to the longitudinal direction; and
a sensor for detecting the tilting.

2. The running board according to claim 1, wherein the board is pretensioned.

3. The running board according to claim 1, wherein the sensor comprises a microswitch that is assigned to the board and the holder.

4. The running board according to claim 3, wherein the sensor comprises two microswitches that are assigned to different ends of the board in the longitudinal direction.

5. The running board according to claim 1, wherein the holder is adjustably mounted and driven via a drive.

6. A flap system for a motor vehicle, the flap system comprising a flap to which the running board according to claim 1 is assigned.

7. The flap system according to claim 6, wherein the flap is driven via an additional drive as a function of the tilting.

8. The flap system according to claim 6, wherein the flap system is operated in such a way that a warning is issued as a function the tilting.
